(19) United States
(12) Patent Application Publication
(10) Pub. No.: US 2013/0050741 A1
(43) Pub. Date: Feb. 28, 2013

(54) SYSTEM AND METHOD FOR PRINTING FROM PORTABLE DEVICES

(71) Applicants: Asad Khalid Raja, Bristol (GB); Thomas William Stuart, Wellingborough (GB); Richard Henry Bay, Brentwood (GB); Samuel Luke Mills, Somerset (GB)

(72) Inventors: Asad Khalid Raja, Bristol (GB); Thomas William Stuart, Wellingborough (GB); Richard Henry Bay, Brentwood (GB); Samuel Luke Mills, Somerset (GB)

(73) Assignee: XEROX CORPORATION, Norwalk, CT (US)

(21) Appl. No.: 13/220,101

(22) Filed: Aug. 29, 2011

(51) Int. Cl. G06K 15/02

(52) U.S. Cl. 358/1.15

(57) ABSTRACT

An imaging forming system and method are disclosed having a print engine, a signal detector and a communication module for communicating with portable devices and printing documents therefrom. A user intent to print from a portable device is ascertained based on a signal strength of each portable device. The signal strength detected determines when each portable device is within a proximate area of the system. If a portable device is within the proximate area for a predetermined period of time, the system operates to print the document.

### BACKGROUND

This disclosure relates generally to ionographic or electrophotographic imaging and printing systems or image reproduction machines, and more particularly is directed to printing systems and methods that print a document according to different criteria.

People can utilize laptops and handheld devices to create documents while on the go, traveling, transitioning from one place to another, working in remote environments away from home, or from a variety of different environments. But until recently, printing those documents could be tricky. Handheld devices, for example, often have scaled-down operating systems that do not always have built-in printing capabilities. Laptops can print, but only if the user can find a printer, connect to it and install the right driver. Other alternatives are not always as feasible, such as saving a document to disk and visiting a copy shop, which is not always conveniently located. This can be even more challenging in remote regions of the world, and not especially easy for devices that don't have disc or CD-R drives, or other forms of removable storage media.

Mobile printing is a generic term for products and services that let people print documents when they are away from a traditional network or a local printer. Usually, mobile printing is wireless. It often uses Bluetooth or 802.11 networking (both of which use radio waves) to communicate. Some older handheld devices use infrared signals, similar to the signals most TV remote controls use.

Many problems are inherent in using mobile devices to print. PDAs, for example, often use scaled-down versions of programs, and sometimes their operating systems do not include print capabilities at all. In order to print from many PDAs and smart phones, a user must first download printing software. That software has to efficiently process documents so the print job doesn't overwhelm the device's memory. In addition, documents printed from handheld devices don't always look like they do when printed from desktop or laptop computers. This is because handhelds don't have enough processing power to handle print output very well. The printing software often has to simplify or modify the document for printing. Also, since handhelds have less memory than laptops it can take longer for them to process print jobs. Further, some mobile printing programs work a little differently where the device sends documents to fax machines rather than printers. The process works just like faxing over e-mail. The user selects an e-mail message that has a document attached and then enters a fax number.

Quite often a person may find a document or email on a portable device that needs immediate printing. Therefore, a need exists to efficiently and effectively transfer documents from portable devices without transferring the document via email, via an office personal computer (PC) or via a removable memory such as a memory card.

### BRIEF DESCRIPTION

The following presents a simplified summary in order to provide a basic understanding of one or more aspects of the disclosure. This summary is not an extensive overview and is neither intended to identify key or critical elements, nor to delineate the scope thereof. Rather, the primary purpose of the summary is to present some concepts of the disclosure in a simplified form as a prelude to the more detailed description that is presented later.

Methods and systems are disclosed to facilitate a proactive file transfer based on automatic vicinity detection so a user can directly and timely print documents from portable devices (e.g., cell phone, tablets, or the like) to a multi-function device (MFD) via a wireless connection. An MFD may include an office or home machine which incorporates the functionality of multiple devices in one, in order to have a smaller footprint in a home or business setting, or to provide document management/distribution/production in a larger office setting. An MFD may operate with different functional combinations including, but not limited to printing, scanning, photocopying, faxing, and e-mailing.

In one exemplary embodiment, an MFD can be an image forming system that comprises a processor with a memory as well as various printing components for processing various functional operations in combination, such as print job request, email requests, photocopying requests, scanning requests and the like. The image forming system includes a signal detector that detects one or more portable devices and identifies signal parameters of the device's signal, such as the signal strength/amplitude, frequency, and the like of each portable device detected. For example, the signal strength of each device can vary depending upon each device's location with respect to the image forming device. The portable devices may comprise any wireless device that communicates with the image forming device, such as cell phones, tablets, laptops, and the like. A communication module of the image forming device is configured to communicatively connect with the one or more portable devices wirelessly. Each device is detected through a communication link that is established with the communication module. The communication module retrieves contents of a document to be printed from the one or more portable wireless devices via the communication link established. In response to certain criteria, a print engine of the image forming device generates an image of the document's contents to a media, such as paper media or other type medium. The criteria may include a signal threshold for a strength of the signal, a designated location of the document being on the portable device, as well as criteria related to proximity of the portable device and other signal parameters other than signal strength or amplitude. The criteria may also include receiving a user confirmation and/or security code at a user interface of the image forming system, for example.

In another exemplary embodiment, an image forming system is disclosed as having a first image forming device and a second image forming system. The first image forming system and the second image forming system include a processor having a memory, a printing module having printing components for processing a print job request from user of a portable device and to print a document from the one or more portable devices located within a proximity of at least one of the first and/or second image forming device. A signal strength detector detects the signal strength of each portable device, and based on the signal strength signals the document to be printed. A communication module is configured to communicate via a communication link with the portable devices. Contents of the document are retrieved from the one or more portable devices for printing by automatically detecting a user's intention to print from each portable device.

In yet another embodiment, a method is disclosed for printing on an image forming system. A proximate area is scanned for one or more portable devices. Once a portable device is detected within the area, a signal detector monitors signals parameters, such as the signal strength of each detected device. For example, a determination is made whether the signal strength meets a threshold strength. Upon meeting the threshold strength, the document is printed on the image forming system.

The following description and annexed drawings set forth in detail certain illustrative aspects and implementations of the invention. These are indicative of only a few of the various ways in which the principles of the invention may be employed.

### BRIEF DESCRIPTION OF THE DRAWINGS

FIG. 1 is a schematic representation of an exemplary image forming system according to one aspect of the disclosure;

FIG. 2 is a schematic representation of an exemplary image forming system according to another aspect of the present disclosure;

FIG. 3 is a graphical representation of signal strength detected over distance in an exemplary aspect of the present disclosure;

FIG. 4 is a diagram illustrating an exemplary aspect of the present disclosure;

FIG. 5 is a diagram illustrating an exemplary aspect of the present disclosure;

FIG. 6 is a diagram illustrating an exemplary aspect of the present disclosure;

FIG. 7 is a diagram illustrating an exemplary aspect of the present disclosure;

FIG. 8 is a user interface screen according to an exemplary aspect of the present disclosure;

FIG. 9 is secure print screen according to an exemplary aspect of the present disclosure;

FIG. 10 is a user interface screen according to an exemplary aspect of the present disclosure; and

FIG. 11 is a flowchart detailing an exemplary method for an image forming system.

### DETAILED DESCRIPTION

One or more implementations of the present disclosure will now be described with reference to the attached drawings, wherein like reference numerals are used to refer to like elements throughout. Aspects of the exemplary embodiment relate to a system and methods for printing from wireless devices in an image forming system or an image forming station that proactively generates print job requests and transfers files based on automatically detecting a user's intention to print from the device. Thus, a user of a portable device is able to automatically print a document, such as an email, a word document, a graphic image, text, a .pdf document, presentation slides, etc. to a printer station or image forming system directly through a wireless communication link between the image forming system and the portable device. A printer station, such as an image forming system/station automatically detects the signal of any number of portable devices and monitors signal parameters, such as the amplitude of the signals generated by the devices detected. According to a set of criteria, such as the signal strength of each device detected and/or detected document contents being within a file location on each portable device, the image forming station ascertains the user's intent to print and processes a print job request for the contents, which may include graphical images, symbols, text, numbers, alphabetic characters, alphanumerical content and the like.

For example, an image forming system may include multiple image forming devices. Each image forming device may be interconnected with one another or may be operated independently from a network, which may be a centralized network or a decentralized network. The system and/or each device scan a surrounding area or a proximate area for portable devices. The portable devices may include mobile phones, tablets, laptops, personal digital assistants (PDAs), handheld devices and any other wireless device. The proximate vicinity of each portable device is monitored. The monitoring of each portable device may be performed according to criteria including each device's signal parameters, thresholds for the parameters, content location for the document to be printed, and/or the proximity of the user device within a proximate area of the system for a predetermined amount of time. For example, proximity may be monitored according to a global positioning system (GPS) location, other navigational positioning system, tracking systems, optic scanning systems, vectoring systems, wave pattern recognition systems and the like for ascertaining position of each the portable device.

An MFD, such as an image forming device continues scanning its surrounding area or proximate area. The image forming device automatically detects a user's vicinity based on a set of pre-defined thresholds based on signal strength within a certain time-window. If a user is within a threshold area and his/her portable device's shared folder is non-empty, a ‘secure print’ dialog appears on the image forming device's local user interface, such as in a user list, and the documents from the shared folder are proactively transferred to the image forming device for printing. A secure print dialog and the transferred documents are automatically removed or deleted from the device if the user moves away from the threshold or proximate area of the image forming device. In some cases depending on user's vicinity, the print job can be automatically moved from one device to another closer-by station. This provides several benefits for printing wirelessly from portable devices, such as ease-of-use with or without explicit print submission from mobile device, proactive and timely document transfer to printing systems via a wireless connection (without hopping through email servers or a mobile print service), and automatically job switching from one station to another without resubmitting.

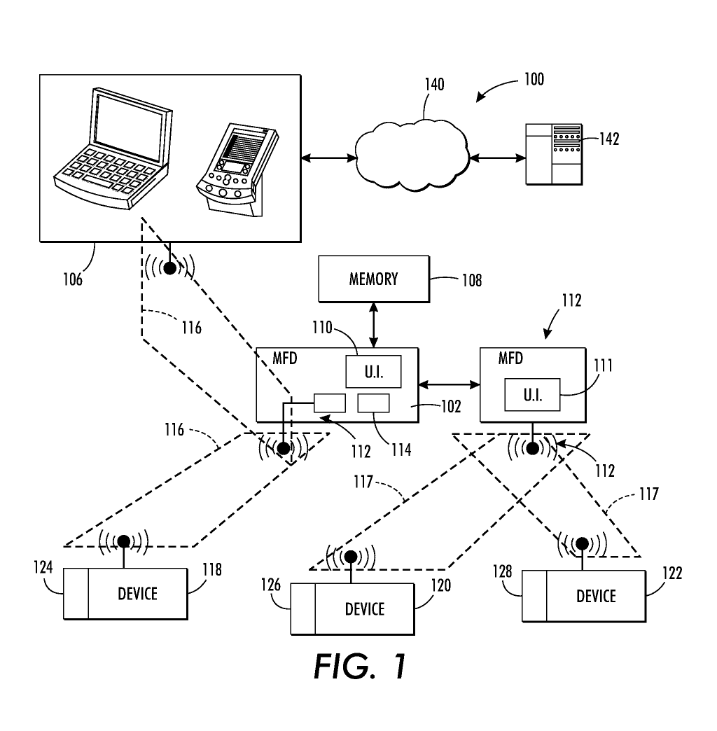

FIG. 1 illustrates one embodiment of an exemplary image forming system 100 for creating a print job request on an image forming station/device of a document using a portable device. A first image forming station 102 and a second multi-function station 104 are configured to communicate with one or more portable devices 106, such as a mobile device, tablet, laptop and/or the like. In addition, the devices 106, for example, may have other network communications to a network 140 with a data base or server 142.

The multi-function devices 102, 104 comprise a memory 108 for storing instructions that are executed via a processor therein. The first image forming station 102 includes a user interface 110, a communication module 112, and a signal detector 114 for detecting signal parameters, such as signal strength or power, frequency, and/or amplitude of the portable devices 106. In addition, the second image forming system 104 of the system 100 and the system 100 independently can also include a user interface 111, a communication module 112, and a signal detector for detecting signal strength of the portable devices thereat.

The image forming stations or systems 102, 104 are configured to establish a communication link 116 with portable devices 106 that are within range of a surrounding area from the communication module 112. The communication link 116 provides a wireless communication link between portable devices 106 and at least one of the image forming stations 102, 104. For example, a wireless communication protocol may be used to communicate in various communication protocols, including, but not limited to, FM, AM SSB, WiFi, ZigBee, Bluetooth, Radio Broadcast Data System, 802.11 b/g/n, 802.15.4 communication protocols. Other portable devices 118, 120 and 122 are also able to establish a communication link with different image forming stations, such as the second image forming station 104 of the system 100 and/or with different communication protocols. For example, the first image forming station 102 has a communication link 116 with a portable device 118 and the second image forming device 104 has a communication link 117 with devices 120 and 122.

The communication module 112 may include a transceiver for transmitting and/or receiving communication data thereat. The transceiver may be an active transceiver with its own power source or passive, as well as communicate in the various communication protocols mentioned above with different devices including non-portable devices and portable devices.

In one embodiment, the image forming stations 102, 104 are configured to ascertain a user's intent to print from a portable device based on certain criteria, such as the signal strength of the portable device, contents in the user's shared folder on the portable device in communication with the image forming station, and/or other criteria. For example, the image forming stations are adapted to detect signal strength of the portable devices 106, 118, 120 and 122 respectively with a signal detector, and to determine whether or not each of the portable devices intends to print. For example, the first image forming device 102 determines the signal strength of the portable devices 106, 118 with the signal detector 114. The signal parameters of each device may vary depending upon the location and vicinity of each portable device 106, 118 in relation to the first image forming station 102. Portable devices 106 may have a different signal parameter (e.g., signal strength or the like) detected than the portable device 118, which are in communication with the first image forming station 102. Based upon the criteria, the image forming device 102 initiates a print request for a print job in a data structure or job queue in the memory 108.

Each image forming device of the system 100 has a proximate area that determines a threshold (not shown) for a signal of a portable device. For example, when the device 118 that is in communication with the first image forming station 102 enters into a first proximate area (not shown) of the station 102, the signal strength of the device 118 meets the criteria including the threshold strength as detected by the signal detector 114. In response, station 102 determines that the device 118 has an intent to print thereat.

In addition, station 102 can make a determination of the user's intent print based upon criteria for whether contents of a document are located in a location on a user's portable device. For example, the portable devices 118, 120 and 122 may have a document in designated location such as a shared folder 124, 126, and 128 respectively, in which the image forming station 102 that is in communication with the device detects. As such, the station 102 can process a print job request based upon a shared folder of the user being non-empty, as well as other criteria, such as the signal parameters detected of the user's portable device, which can indicate that each device with the intent to print is within the first proximate area for the station.

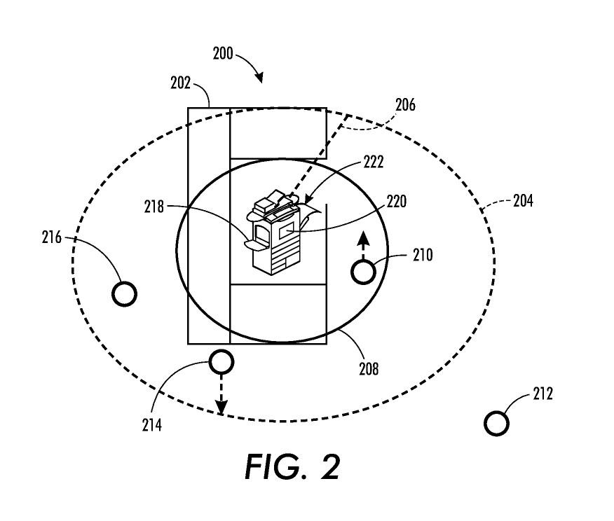

Referring now to FIG. 2, illustrated is an exemplary image forming station 200 that is located in a setting 202, such as an office environment that may be interconnected to other MFDs, in a home or other environment. The station 202 comprises any number of MFDs having a print engine as well as components therein for printing not shown, such as a photoreceptor belt/drum for generating latent images thereon, a transfer station for transferring toner from the belt to a paper media, a charging station for charging the photoreceptor, a fusion station for fusing toner matter, or other printing components that are not illustrated or described here in detail and can be appreciated by one of ordinary skill in the art.

The image forming station 200 includes a detection area 204 in which portable devices 210, 214, and 216 such as a user's cell phone or other wireless device is able to establish a communication link with the station 200. A device 212 is illustrated as being outside of the area 204, and therefore, not in communication with the station 200. The detection area 204 includes a radius 206 that determines a range of communication for station 200. The station 200 includes a signal detector 220 for detecting signal parameters of the devices and further includes a threshold area 208 in which signal parameters, such as signal strength or amplitude of the one or more portable devices is determined as meeting a threshold criteria. Upon detecting the signal of one or more of the portable devices as within the threshold area 208, the station 200 determines that the user of each portable device therein may have an intent to print. Other criteria for ascertaining a user intent to print from one of the portable devices on the system 200 may also include the location of content at a designated location on the portable device, such as a print folder, a shared folder, or any other data pathway location designated for printing. In addition, the proximity of each portable device 210, 212, 214, 216 in relation to the station 200 may also be one of the criteria for determining an intent to print.

For example, each of the portable devices 210 through 216 is depicted in various locations. The system 200 determines according to a set of criteria whether each device has an intent to print from the system 200. The criteria for printing at the station 200 may include certain signal parameters of the devices meeting signal thresholds, a proximity of a device in relation to the system, the location of content in a designated location of the portable device 210, and/or other criteria. For example, the user of portable device 210 is detected by the system 200 as within the threshold area 208. The signal of the device 208 may be detected by the station and based on the signal strength, for example, exceeding a threshold level, the station 200 may generate a print job request in a data structure memory or queue(not shown) of the system 200. The system 200 can thus automatically and dynamically generate printing at a print engine 218 based on the detected signal parameters of the device 210.

In addition, other criteria may be taken into account for ascertaining the user's intent to print from portable device 210, such as whether content or a document is located within a designated location of the device 210. Other criteria may also be provided for initiating printing at the print engine 218. Further, while the proximity of the portable devices 210, 214 and 216 that are in communication with the station 200 may be ascertained according to a signal parameter, such as signal strength or power, amplitude, or frequency, the proximity or location in relation to the station may also be monitored with other location capabilities communicatively coupled with the station 200. For example, the signal detector 220 may include gps systems, RFID tags both active and/or passive, sensor network triangulation modules and the like. For example, active RFID systems determine position based on the presence of the object in a particular area, within range of a signal detector such as an RFID scanner. When a user or portable device having an active RFID tag enters a room, setting 202, or proximity threshold area 208, for instance, the system indicates the existence of that user or device as soon as it detects the tag's signal.

In addition, the signal detector may include a sensor network, such as sensor networks like ZigBee and DigiMesh, which function on the principle of TDOA or Time Difference of Arrival. Basically, the time that elapses before a signal emitted from the transmitter bounces back to the emitter from the tracked object. As such, three or more sensors may be implemented by the signal detector to triangulate the user's position.

In another embodiment, a user's intent to print may be ascertained by the system 200 depending upon the movement of the portable devices. As the portable devices move toward the system 200 (indicated by the arrow of device 210), such as the portable device 210, different threshold areas of different radii may be used to determine that the user intends to print at the particular printing or image forming system 200. Thus, another criteria used of a set of criteria to determine a user of a portable device's intent to print can be the direction of movement over a certain period of time toward the device. For example, as the device moves toward the image forming system, and also has a document in a shared destination print folder, the system 200 detects the direction of movement over a short period of time as well as content to be printed in the user portable device. The system therefore generates printing or a print job request in its memory queue for printing. Upon leaving the area before a print job initiates, the system 200 determines that the user has no intent to print and either deletes any print request and/or ceases generating the print job.

For example, FIG. 2 illustrates one embodiment of the portable device 214 moving away from the system 200 (as indicated by the arrow of device 214) within the detection area 204. Communication between the system 200 and the device 214 is established through a wireless communication link within the detection area. If the device 214 was previously within the threshold area 208 for determining a positive intent to print from a user device, the system 200 would no longer process the intent of the device as wanting a print job. Consequently, any document content transferred to the system 200 for printing would be deleted and any pending job request cancelled. As such, as the device 214 move out of the detection area 204, as shown by the arrow attached, the system no longer detects or is able to communicate directly with the device. Within an office setting 202 or other type setting multiple image forming systems may have detection areas and threshold areas for detecting portable device signals and ascertaining a portable device's intent to print to each particular system. For example, as shown in FIG. 1, discussed above, the image forming system may comprise more than one printing or image forming station/system where first and second station may be in communication with another. Therefore, as the portable device 214 leaves the detection area 204 for the image forming system 200, the portable device could enter a detection area for a second image forming system (not shown) that also ascertains a user's intent to print from a portable device based on a set of criteria similar to the set of criteria discussed above by which system 200 ascertains the user's intent to print.

In one example of an embodiment, the image forming system 200 scans the threshold area 208 in a time interval, such as 60 seconds or some other time interval, for example, with respect to the signal strength or other signal parameter of the portable devices 210, 214 and 216 detected. If a user is within that area, a ‘secure print’ dialog can appear on a local interface 222 of the image forming system 200. If there is more than one user in the threshold area, then the names may appear on a list (not shown) or on the interface 222. In a first predetermined time, the MFD or image forming devices discussed above scans for new portable devices in the whole radius whilst monitoring the existing ones. At the end of the first predetermined time interval (e.g., ten seconds or any other interval), the image forming system stops looking for new portable devices to detect and monitors the strength of the existing ones.

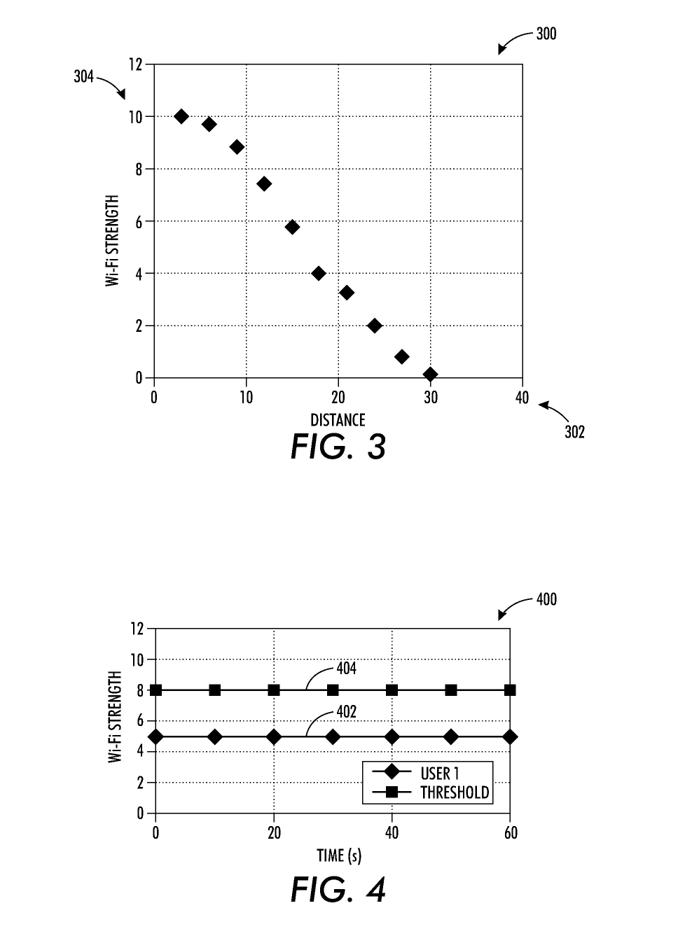

Referring now to FIG. 3, is illustrated a graph 300 showing distance 302 along a horizontal axis and a signal strength 304, such as a WiFi signal strength for example, along a vertical axis. Each diamond or dot on the graph 300 demonstrates the relationship of a portable device's signal strength with respect to a distance from an image forming station (e.g., the image forming station 200 of FIG. 2 and/or the first image forming station 102 and the second image forming station 104 of system 100 of FIG. 1). The graph 300 provides a rough estimate of how a WiFi signal strength decreases over distances from an image forming system. Although WiFi signals strength is discussed, any other communication protocol format, such as Bluetooth, or other protocols, as mentioned above, may also be used and the present disclosure is not limited to WiFi communications. In the example of FIG. 3, it can be assumed that the relationship of signal strength to distance is linear and decreases with a negative slope with increasing distance.

For example, at around 30 metres indoors (or some other standard measurement unit), the signal strength has reached its maximum propagation distance. An MFD or image forming device therefore scans its proximity for devices communicating, which is the second concentric circle in FIG. 2 discussed above as the detection area 204, for example. This can be anywhere from a metre to 7 metres away from the machine, or some other distance depending on the preference of the customer, or an arbitrary value of say, 6 metres, could be chosen for all image forming stations in the system. Any range from the system to a radius of a proximate area for detecting signal parameters of the portable devices could be envisioned for ascertaining an intent to print from a user.

FIGS. 4-7 are described in relation to FIG. 2 as an example for illustration and ease of description. However, FIGS. 4-7 are not limited to the exemplary embodiment of FIG. 2 and are applicable to other embodiments discussed herein, such as illustrated in the system 100 described in FIG. 1 and elsewhere.

FIG. 4 illustrates a graph of the device 216 within the detection area 204 of the system 200. The device 216 is stationary (e.g., at his workplace), and thus, a signal strength 402 of the portable device is constant. If the signal strength passes over a threshold 404, a secure print message will appear over the user interface 222 for as long as the signal strength is above the threshold.

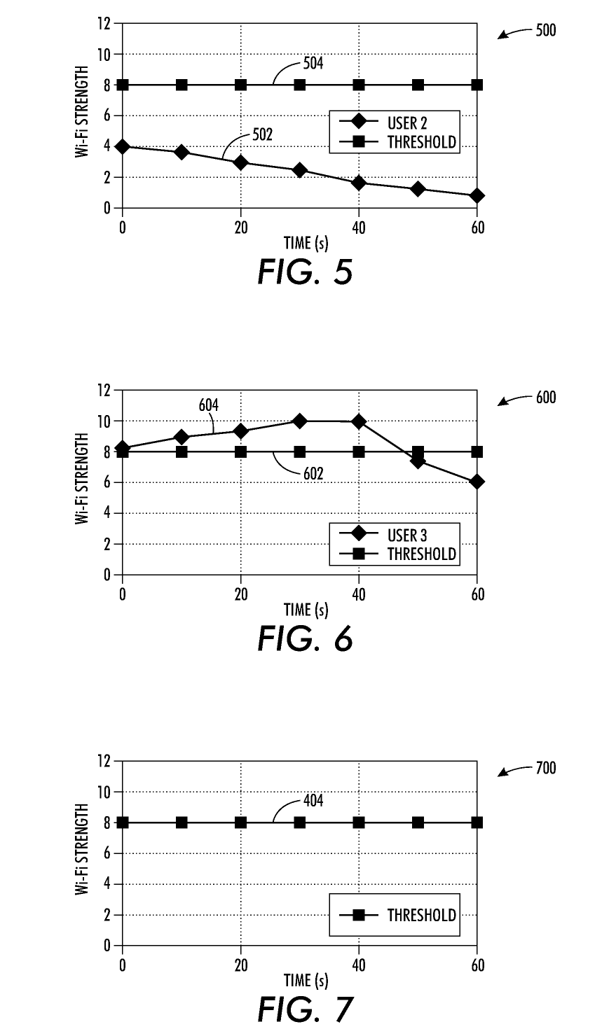

FIG. 5 illustrates a graph 500 of device 214 that is within the detection area 204, but is in the process of moving away from the image forming system 200. A signal strength 502, for example, of the device is shown as decreasing in strength as the device 214 moves away. A signal threshold 504 defines the threshold area and is shown relative to time along the horizontal axis. As such, the user device 214 is never within or exceeds the threshold 504 to be within a threshold area of the system, and thus, no documents are printed from the portable device 214 according to a criteria for signal strength. Other signal parameters and criteria may also be used to determine a user's intent to print and the disclosure is not limited to only the strength of the signal, as discussed above.

FIG. 6 illustrates a graph 600 of the device 210 that is moving closer to the system 200. As such, the device 210 was already within the area close to the proximity of the system 200 by exceeding a threshold 602 when a counter (not shown) of the system 200 may have started and was moving towards the machine, hence a signal strength 604 rises to a maximum of ten. Thus, for the first 40 seconds, a secure print dialog, further discussed below, appears on the system's user interface 222, but since the user moved away from the machine after approximately 45 seconds, the signal strength fell below the threshold. Consequently, the secure print dialog will disappear and the print job is cancelled along with any other document content that was transferred from the device 210 to the system 200.

FIG. 7 illustrates a graph demonstrating that the device 212 was outside of the detection area of the system 200 for the system to detect a communication signal therefrom. As such, only the threshold signal line is depicted.

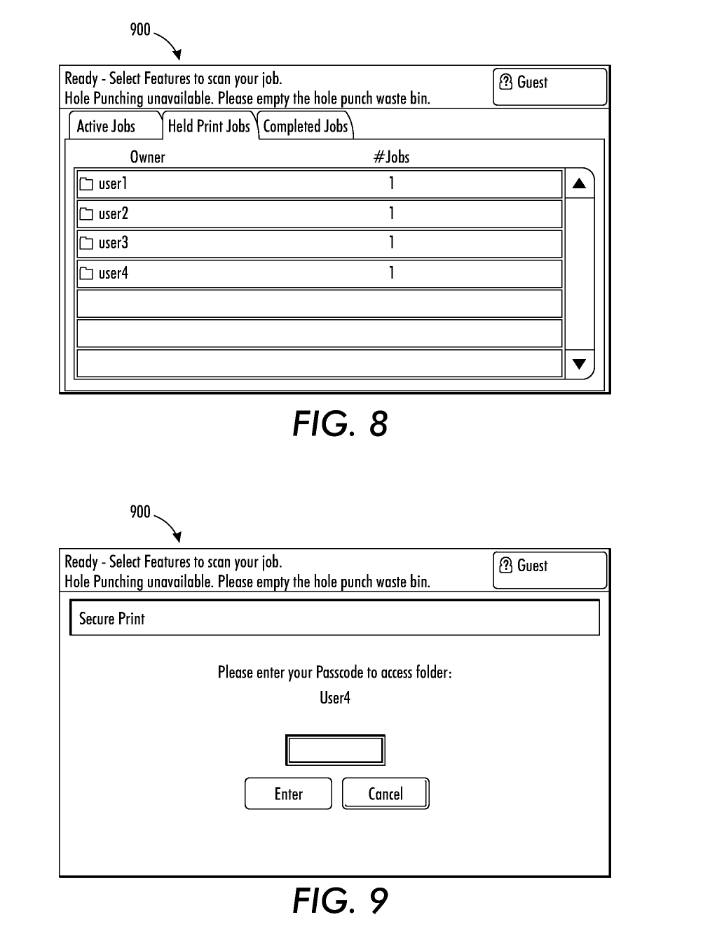

FIG. 8 illustrates a print job screen 800 for print jobs stored in a print queue of image forming systems disclosed herein. As portable devices enter into the threshold area and meet the criteria for ascertaining a user's intent to print each image forming station transfers a user's file and/or the contents of a designation file location or pathway from the portable devices. Multiple portable devices are therefore able to print by providing documents into the shared file location and move toward or within a threshold area of the image forming system in order to meet demonstrate the intent to print the contents from the system.

FIG. 9 illustrates a secure print screen 900 for a user of a portable device that has a print job transferred to an image forming device based on signal parameters or other criteria to ascertain an intent to print, such as having contents in a print location designated for printing. Once the user arrives at the image forming system the user can enter a confirmation to print the document thereat or provide security codes to a user interface control 902 in order to access the print job. The confirmation or code can be entered so that no other person or device can access that print job, for example.

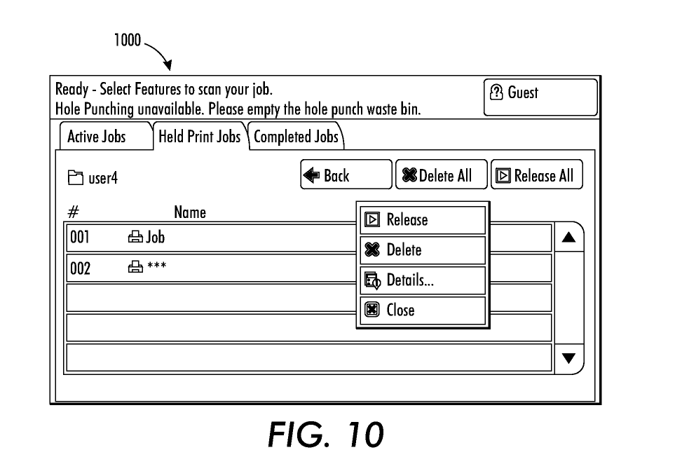

FIG. 10 illustrates another exemplary embodiment of a user interface screen 1000 that is provided to the user of the portable device that has transferred a print job from the portable device to an image forming system. Once the user has accessed the system, options are provided in the interface to release the print job for printing at a print engine, delete the job, see details or close the screen. Other options and user interface controls may also be provided as one of ordinary skill in the art will appreciate.

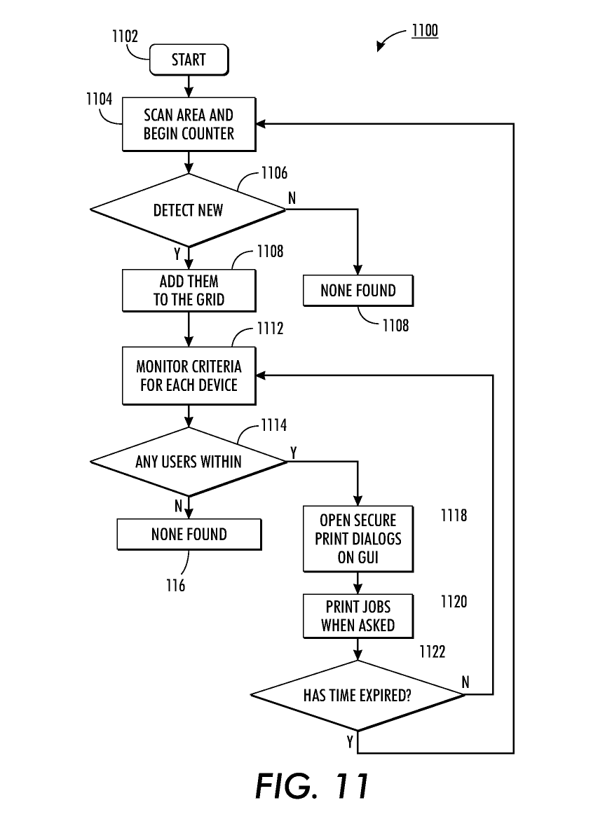

An example methodology 1100 for implementing a method to print with an image forming system from portable devices is illustrated in FIG. 11. Reference is made to the figures described above for ease of description. However, the method 1100 is not limited to any particular embodiment or example provided within this disclosure. While the method 1100 is illustrated ion FIG. 11 and described below as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the description herein. Further, one or more of the acts depicted herein may be carried out in one or more separate acts and/or phases.

At 1102 the method 1100 initiates. At 1104 a proximate area 208 or a threshold area of an image forming system 200 is scanned for any portable device. For example, a communication module or a signal detector scans the proximity of the image forming station for a wireless communication signal or portable device communication signal.

At 1104 the image forming system 200 scans a detection area 204 and/or a threshold area 208 for a portable device, such as mobile phone or other portable devices that have a wireless communication connection. At 1106 a determination (Y/N) is made as to whether any new portable devices are detected within the proximity of the image forming system. If no devices are detected, as shown at 1108, then the determination answer is N and the method continues at 1112. However, if the answer is yes (Y), the method flows to 1108 where the newly detected portable devices are added to a communication grid or link with the image forming device, and the method continues at 1112 where a set of criteria is monitored for each device in order to ascertain each user's intent to print. The criteria include signals parameters, print content at a location on each device, the location of each device and/or other criteria that may be user define or not. For example, signal strength, signal amplitude, frequency are signal parameters that may be monitored together with other criteria that indicates a user's intent to print from a particular image forming system from among a plurality of systems.

At 1114 the system 200 questions whether any portable device detected is within a threshold area 208. If the user is within the threshold for a certain time, the criteria may be met. Other criteria may also be determined in addition, such as the location of content on each device, and/or proximity information as also meeting a threshold for a period of time. In addition, the movement of the device toward or away from the imaging system may also be used to meet a criteria threshold. If the determination at 1114 is N or that no users are within a threshold criteria, the method re-flows back to 1112 where the devices within a detection area in communication with the image forming devices continue to be monitored. If the determination at 1114 is yes (Y), then the process continues at 1118 where an open secure print dialog or a user prompt screen is provided at the image forming system for a user to interface with. After a predetermined amount of time at 1122, the system determines whether the user's intent is still to print by continuing the process flow back to 1112 where the device is still monitored for meeting certain criteria. If time has expired then a signal detector and/or communication module of the system begins scanning at 1104 for new portable devices that may have entered proximate enough to the system to establish communication.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following him claims.

What is claimed:

1. An image forming system, comprising:
a processor having a memory;
a signal detector that detects one or more portable devices and identifies at least one signal parameter for each portable device detected;
a communication module that is configured to communicatively connect with the one or more portable devices detected through a communication link and to retrieve contents of the document to be printed from the one or more portable wireless devices via the communication link; and
a print engine that generates an image of the contents of the document to a media based on the processor ascertaining a user's intent to print from the portable device according to a set of criteria.

2. The system of claim 1, wherein the print engine prints the document from the one or more portable devices based on the criteria including whether the parameter detected reaches a signal strength threshold.

3. The system of claim 1, wherein the print engine has a database or job queue that populates the database or job queue with a job request when the parameter of the one or more portable devices meets a signal strength threshold as detected by the signal detector and the contents of the document are communicatively transferred via the communication link from a designated file location for printing from the one or more portable devices.

4. The system of claim 1, wherein the communication link is a wireless communication link in which the communication module communicatively connects to the one or more portable devices to initiate a print request of the document and/or retrieve the contents for printing the contents of the document from the one or more portable devices.

5. The system of claim 1, wherein the communication module is a wireless communication module that establishes the communication link with the one or more portable devices and communicates over the communication link to a plurality of portable devices for printing documents based on the criteria including a location detected of each device for a predetermined time period.

6. The system of claim 1, wherein the print engine is coupled to printing components including a photoreceptor and a transfer station to transfer an image of the document to the media, and wherein the print request of the document is deleted from a data structure or job queue in the memory by the processor when the signal strength detector detects that the one or more portable devices are no longer within a proximate area of the image forming system.

7. The system of claim 1, wherein the communication module scans the proximate area for a predetermined time period at first predetermined time intervals to detect portable devices not yet detected and communicates with one or more portable devices already detected to be within the area during second predetermined time intervals.

8. An image forming system, comprising:
a first image forming system and a second image forming system that include:
at least one processor having a memory;
at least one printing module having printing components that print a document from one or more portable devices onto a media;
at least one signal strength detector that detects at least one signal parameter of each portable device; and
at least one communication module that is configured to communicate via a communication link with the one or more portable devices and to retrieve contents of the document from the one or more portable devices for printing based upon the at least one signal parameter detected by the signal strength detector;
wherein the printing module prints the document retrieved by the communication module based upon the signal parameter detected.

9. The image forming system of claim 8, wherein the first image forming system and the second image forming system are communicatively coupled via a network link and include a user interface that provides a dialog to each user of the one or more portable devices, wherein the user interface provides one or more controls that receive input from the user to initiate printing of the document to the media and/or to initiate retrieval of the contents from the one or more portable devices.

10. The image forming system of claim 9, wherein the signal strength detector of the first image forming system and the second image forming indicates whether the one or more portable devices is within a first proximate area for the first image forming system to print and a second proximate area for the second image forming system print and that the document is to be printed from the one or more portable devices based on a designated location of the document on the one or more portable devices.

11. The image forming system of claim 8, wherein the first image system includes a first proximate area and the second image system includes a second proximate area that does not overlap with the first proximate area, and the content of document is retrieved by the communication module of the first image system and/or the second image system according to a signal strength of the one or more devices detected by the signal strength detector and the document being located in a designated location in the one or more portable devices.

12. The image forming system of claim 8, wherein the first image forming system cancels the contents of the document retrieved and/or printing of the document upon no longer detecting that the one or more portable devices is within a first proximate area associated therewith and the second image forming system retrieves the content of the document for printing and/or initiates a print request upon detecting that the one or more portable devices are within a second proximate area associated therewith based upon the signal strength of the communication link detected from each one of the portable devices.

13. The image forming system of claim 8, wherein the communication module communicates via the communication link with the one or more portable devices that include wireless devices communicatively coupled to the communication module via a wireless communication protocol and retrieves the contents of the document via the communication link based on a signal strength detected reaching a signal threshold strength.

14. The image forming system of claim 8, wherein the printing module of the first image system and the second image system respectively initiates printing of the document after receiving a user input at the user interface or user controls associated with each of the first image system and the second image system.

15. A method for printing on an image forming system, comprising:
scanning a proximate area for a portable device with a communication module;
detecting the portable device within a proximate area;
determining a signal parameter of the portable device in communication with the communication module;
determining whether a user of the portable device intends to print a document based on a set of criteria; and
upon the portable device meeting the criteria, printing a document on the image forming system.

16. The method of claim 15, further comprising:
upon the signal parameter meeting a threshold strength of the criteria, initiating a print request for the document on the portable device in a data structure.

17. The method of claim 15, wherein the printing is in response to the signal parameter meeting the criteria for a threshold strength and in response to the document meeting the criteria for being located at a designated location on the portable device.

18. The method of claim 15, wherein printing the document includes:
providing a dialog to a user on a local interface of the image forming system that secures the document relative to other user's and initiates the printing upon receiving the user's clearance and/or confirmation.

19. The method of claim 15, wherein printing the document includes:
populating a print request in a data structure to print the document upon the signal parameter meeting a threshold, and deleting the print request before printing if the portable device no longer meets the threshold.

20. The method of claim 15, further comprising:
upon detecting that a signal parameter exceeds a threshold strength, transferring contents of the document from the portable device to the image forming system, wherein the threshold strength indicates to the image forming system a proximity of the portable device relative to the image forming system.
